(19) United States
(12) Patent Application Publication
(10) Pub. No.: US 2009/0190142 A1
(43) Pub. Date: Jul. 30, 2009

(54) Method And System For Connecting A Data Storage Device To A Kiosk

(76) Inventors: Steven H. Taylor, Boise, ID (US); William R. Cridland, Boise, ID (US); Michael J. Shelton, Boise, ID (US); Clinton T. Jensen, Caldwell, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/253,128

(22) Filed: Oct. 16, 2008

Related U.S. Application Data
(60) Provisional application No. 61/024,652, filed on Jan. 30, 2008.

(51) Int. Cl. G06F 3/12; G06F 1/16

(52) U.S. Cl. 358/1.1; 361/679.41

(57) ABSTRACT

A system includes a docking port with at least one moveable member for releasably engaging any of a plurality of different data storage devices; at least one data connector disposed adjacent the docking port; and an optical recognition device for locating a data port on the data storage device. The optical recognition device controls relative movement between the data storage device and connector such that the data storage device and connector are automatically interfaced by the system. A method of operating a photo print kiosk includes engaging a data storage device in a docking port having at least one moveable member for securing the data storage device in the docking port; detecting a data port of the data storage device; and automatically interfacing the data port with a matching connector of a plurality of connectors in the kiosk through relative movement of the data storage device and the matching connector.

### BACKGROUND

Many retail stores have installed interactive kiosks in order to allow patrons easier access to quality photograph printing. A user may operate a digital camera to take digital photographs that are then stored electronically as digital image files on the camera or some other data storage device. The user then transfers the digital image files to the interactive kiosk. Once the data is transferred to the kiosk, the user may then edit and print the photographic images. Typically, such kiosks print pictures on photographic print media with a high image quality.

The transfer of digital image files from a camera to a print kiosk may entail several different and cumbersome steps. For example, the use of some traditional data storage devices including compact discs (CDs) or flash memory devices in connection with such interactive kiosks can involve transfers of data that must take place at a location other than at the kiosk. For example, the user of such data storage devices transfers data to the CD or flash memory device, typically from a laptop or home computer, before going to the retail location to then transfer that same data to the kiosk.

In recent years, many other portable electronic devices have developed the ability to generate and/or store digital image files. For example, mobile phones, Personal Digital Assistants (PDAs), MP3 players and similar devices may incorporate a digital camera for taking digital pictures or may at least have the ability to receive, store and display digital image files.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a prospective view of a kiosk according to one illustrative embodiment.

FIG. 2 is another prospective view of a kiosk in connection with a data storage device according to one illustrative embodiment.

FIG. 3 is yet another prospective view of a kiosk with a data storage device, wherein the data storage device is communicatively connected according to one illustrative embodiment.

FIG. 4 is a prospective view of a docking port and a printed circuit assembly disposed in the kiosk according to one illustrative embodiment.

FIG. 5 is another prospective view of the docking port and a printed circuit assembly of FIG. 4 incorporating a data storage device according to one illustrative embodiment.

FIG. 6 is yet another prospective view of the docking port and a printed circuit assembly of FIG. 4 incorporating a data storage device according to one illustrative embodiment.

FIG. 7 is a prospective view of the docking port and a data storage device wherein an optical recognition device detects the position of a data port of the data storage device according to one illustrative embodiment.

FIG. 8 is a prospective view of the docking port and a printed circuit assembly of FIG. 4 depicting the relative horizontal movement of the docking port and a printed circuit assembly according to one illustrative embodiment.

FIG. 9 is another prospective view of the docking port and a printed circuit assembly of FIG. 4 depicting the relative vertical movement of the docking port and a printed circuit assembly according to one illustrative embodiment.

FIG. 10 is a prospective view of the docking port and a printed circuit assembly of FIG. 4 wherein the data storage device is connected to and in communication with the printed circuit assembly according to one illustrative embodiment.

Throughout the drawings, identical reference numbers designate similar, but not necessarily identical, elements.

### DETAILED DESCRIPTION

The present specification describes, among other things, an interactive kiosk and accompanying method for receiving digital image data from a data storage device and allowing a user to edit and print corresponding hardcopy images or photographs. The kiosk provides a system for receiving any of a variety of data storage devices, including a portable electronic device such as a mobile phone, PDA or MP3 player, and automatically interfacing that data storage device with the kiosk so as to allow data transfer while also preventing misuse or abuse by a kiosk user.

As outlined above, in recent years, many portable electronic devices have developed the ability to generate and/or store digital image files. For example, mobile phones, Personal Digital Assistants (PDAs) and MP3 players may incorporate a digital camera for taking digital pictures or may at least have the ability to receive, store and display digital image files.

An example of a widely used MP3 player is the Apple® iPod®. The iPod has the capacity to store digital image files. Similarly, an example of a popular mobile phone is the Apple® iPhone®. Again, an iPhone can both generate and store digital image files. Users of the iPod or iPhone often store image data primarily on these devices instead of other types of data storage devices such as a CD or flash memory device.

Presently, a patron who utilizes a photo printing kiosk has a limited number of options in transferring data from a mobile phone, such as an iPhone, or from an MP3 player, such as an iPod, to the kiosk for printing. One option is to first transfer the data from the mobile phone, MP3 player, PDA or other data storage device not supported by the kiosk to a second data storage device that the photo kiosk does support. That second data storage device is then interfaced with the kiosk to transfer the data to the photo kiosk. This process is cumbersome and time consuming, and often requires an intermediary host computer. Consequently, using a photo kiosk to print image files from a mobile phone or MP3 player can become inconvenient.

One option is to incorporate into the photo printing kiosk an appropriate adapter for data transfer directly to the kiosk from the mobile phone, MP3 player or similar portable electronic device. Currently, such adapters and connectors may be provided at a photo kiosk, but are often subjected to excessive wear and tear due to the retail environment. This frequently renders the adapter or connector nonfunctional. Additionally, the cables associated with the adapters are often dangling from the kiosk producing not as clean, ordered or organized a look as would be desired. Moreover, some users may feel intimidated or may find it difficult to appropriately attach the adapter to their mobile phone, MP3 player, PDA or other data storage device.

Yet another option to transferring data from a data storage device such as a mobile phone or MP3 player to a photo kiosk for printing is to incorporate a docking port or cradle in the kiosk that accommodates that specific data storage device. This may assist some users to interface the data storage device to the kiosk without misalignment and the consequent difficulty or damage. Additionally, this alternative provides a more ordered and organized look for the kiosk.

However, like the cables mentioned above, these docking ports or cradles are subject to excessive wear and tear due to the retail environment. This may render the docking port or cradle nonfunctional. Further, a docking port or cradle is also more readily subjected to vandalism and is easily stolen or misplaced. Moreover, docking ports or cradles are often engineered to fit only specific models of data storage devices. This would make it expensive and difficult to provide a docking port or cradle for each potential data storage device that might be presented. Some users may not know which model of data storage device they have and which adaptor, docking port or cradle will be compatible. This could lead to some users improperly connecting their data storage devices, thus potentially damaging the data storage device or the connector of the docking port or cradle.

To address these issues, as noted above, the present specification describes, among other things, an interactive kiosk and accompanying method for receiving digital image data from a data storage device and allowing a user to edit and print corresponding hardcopy images or photographs. The kiosk provides a system for receiving any of a variety of data storage devices, including a portable electronic device such as a mobile phone, PDA or MP3 player, and automatically interfacing that data storage device with the kiosk so as to allow data transfer while also preventing misuse or abuse by a kiosk user.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

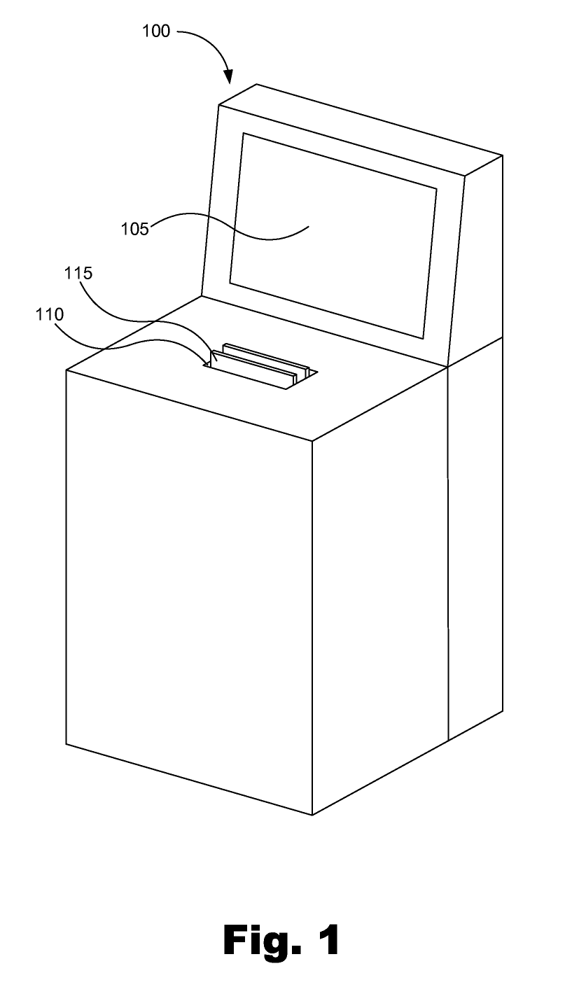

FIG. 1 is a prospective view of a kiosk (100) according to one illustrative embodiment. The kiosk (100) may be positioned in a retail store where patrons of the store may easily gain access to the kiosk. Some kiosks include a user interface (105). The user interface (105) may include, but is not limited to, a touch sensitive screen, keyboard, mouse, or any other device that allows a user to interact with the kiosk.

The kiosk (100) may further include a slot (110). The slot (110) is sufficiently large enough to allow for a flash memory device, mobile phone, MP3 player, PDA or other data storage device to be inserted therein. As will be described in more detail below, the slot (110) and cooperating structure within the kiosk (100) form a docking station (115) that can accept any of a wide variety of data storage devices, including, but not limited to, flash memory drives, mobile phones, MP3 players, PDAs, etc. As will be described below, the docking port (115) provides for a way to automatically connect the data storage device to the kiosk (100) for transfer of data to the kiosk (100).

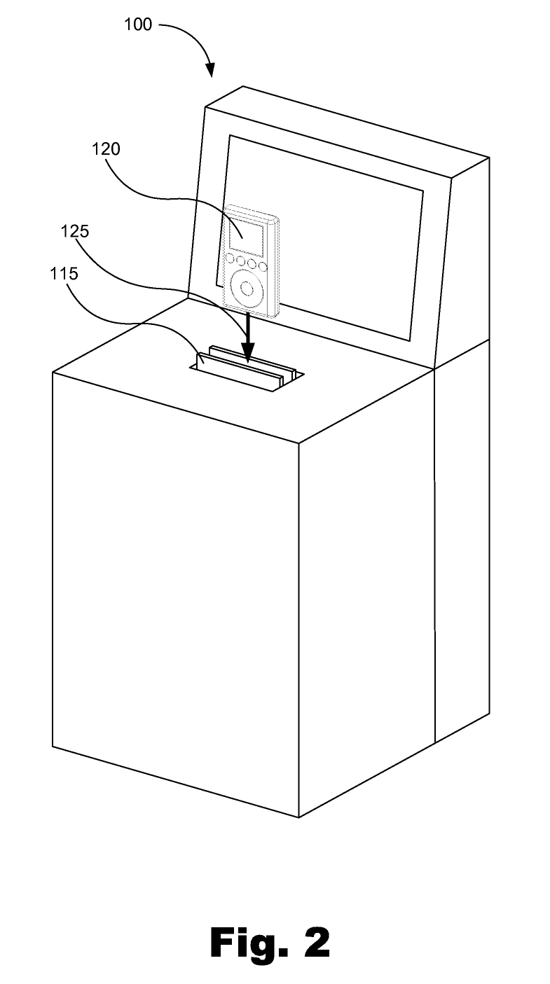

FIG. 2 is a prospective view of the kiosk receiving a data storage device (120). As shown in FIG. 2, the data storage device (120) is placed into the docking port (115) in the direction of arrow (125). As will be discussed below, the data storage device (120) may be oriented by the user for insertion into the docking port (115) so that the data port of the data storage device (120) is in a downward position facing the kiosk (100). The data storage device (120) is depicted here as being an iPod, but it will be understood by one of ordinary skill in the art that any type of data storage device (120) may be used in connection with the kiosk (100).

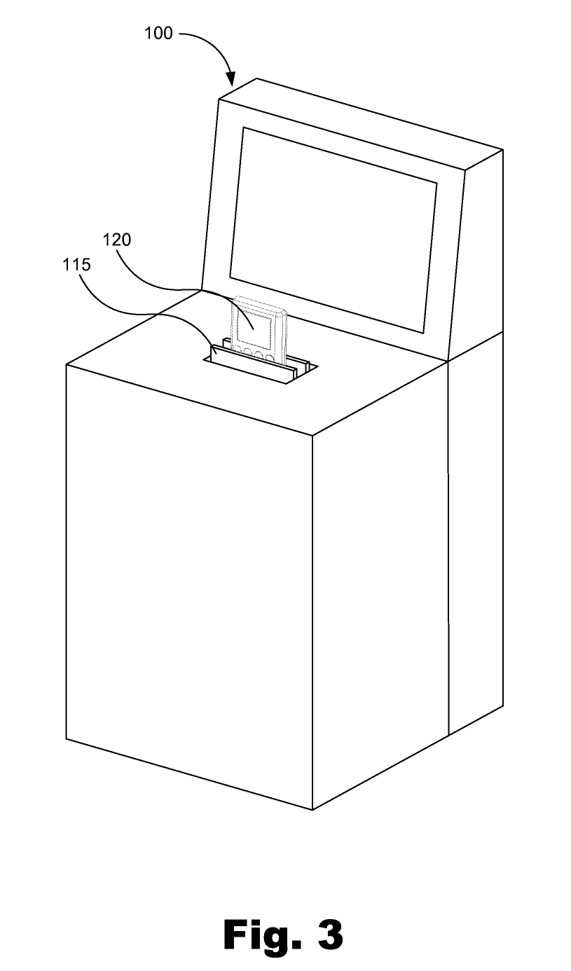

FIG. 3 is a prospective view of the kiosk with a data storage device (120), where the data storage device (120) is secured in the docking port (115) and communicatively connected to the kiosk. Here, the data storage device (120) is fully seated within the docking port (115) and is ready to transfer data to the kiosk (100). As will be described below, the data storage device (120) has been electronically and communicatively interfaced with the kiosk (100) to enable direct data transfer.

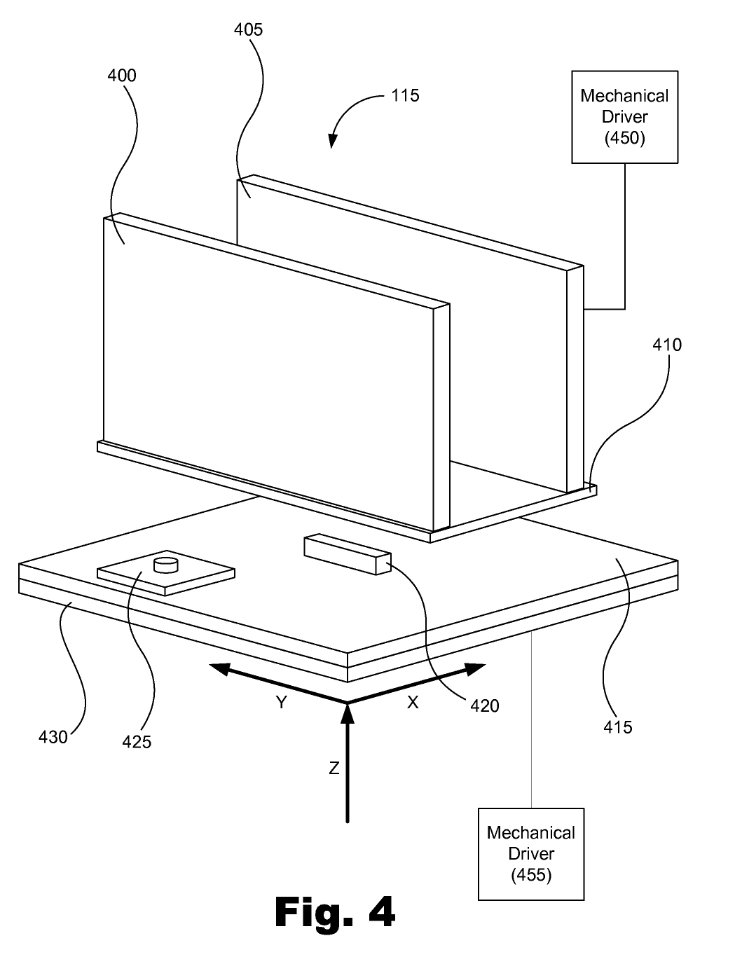

FIG. 4 is a prospective view of some of the internal components of the docking port (115). As shown in FIG. 4, a printed circuit assembly (PCA) (415) may be disposed in the kiosk (100) according to one illustrative embodiment. The docking port (115) may have a first substrate (400) and a second substrate (405) vertically positioned and which are parallel to one another. The first substrate (400) and second substrate (405) may protrude out the slot (110, FIG. 1) of the kiosk (100, FIG. 1). The first and second substrates (400, 405) are moveably mounted on a frame (410) and connected to mechanical drivers (450) located within the kiosk that can selectively move the first and second substrates (400, 405) relative to each other, toward or away from each other, so as to grip a data storage device (120, FIG. 2) inserted therein irrespective of the size, make, model, etc. of the data storage device. The substrates (400, 405) may be covered with padding and/or high friction material, such as rubber or the like, so as to securely hold an inserted data storage device (120, FIG. 2) without potentially scratching or otherwise damaging the surface of the device.

A support frame (410) may be a substrate positioned below the first and second substrates (400, 405). The support frame (410) may also act as a resting platform for the data storage device (120, FIG. 2) once the data storage device (120, FIG. 2) is placed between the first and second substrates (400, 405). As will be discussed in further detail below, the first, second and third substrates (400, 405, 410) may all be driven by mechanical drivers (450) so as to allow for proper alignment of a data storage device (120, FIG. 2) with a connector of the docking port (115).

The PCA (415) may be located entirely within the kiosk (100). The PCA may include a connector (420) and an optical recognition device (425). The connector (420) is engineered to mate with the data port of a data storage device (120, FIG. 2). For example, the connector (420) may be a Universal Serial Bus (USB) connector. Many portable electronic devices include a USB connector that could be interfaced with the connector (420) of the docking port (115).

As will be discussed in more detail below, several alternative connectors also may be provided on the PCA (415) to allow for data transmission from several different types of data storage devices to the kiosk (100). The support frame (410) and substrates (400, 405) may be positioned by mechanical drivers (450) so that a data storage device held between the vertical substrates (400, 405) is positioned with its data port aligned over a corresponding connector on the PCA (415). The optical recognition device (425) functions in a manner so as to allow the data port of the data storage device (120, FIG. 2) to be located and properly aligned with the connector (420).

The PCA (415) is secured to a PCA substrate (430). As an alternative to translating the support frame (410) with respect to the PCA (415), the PCA substrate (430) may be connected to mechanical drivers (455) located within the kiosk (100) to allow the PCA (415) to move horizontally in the X and Y directions as well as vertically in the Z direction. The optical recognition device (425) may communicate with the mechanical drivers (455) that move the PCA substrate (430) in order to align the data port of a data storage device (120, FIG. 2) held between the substrates (400, 405) with the connector (420).

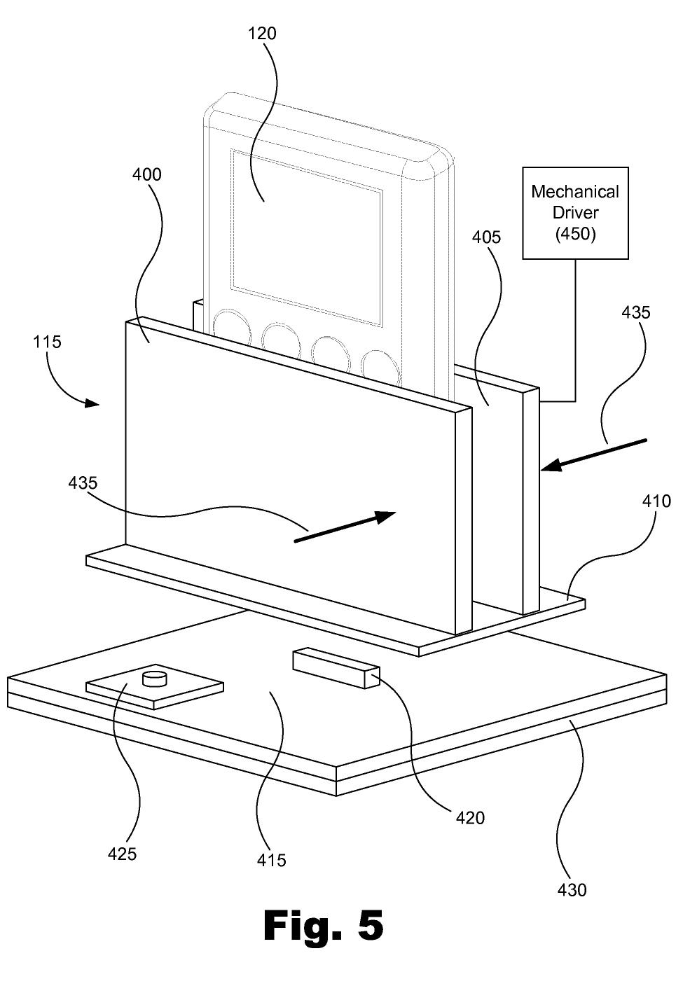

FIG. 5 is another prospective view of the docking port and printed circuit assembly of FIG. 4 receiving a data storage device (120) according to one illustrative embodiment. The method of how the data storage device (120) is aligned with the connector (420) will now be discussed. The user first places the data storage device (120) into the docking port (115) located in the slot (110, FIG. 1) of the kiosk (100, FIG. 1). The first and second substrates (400, 405) of the docking port (115) automatically move together and secure the data storage device (120) so that it will remain stationary with respect to the support frame (410) throughout the data transfer process.

A sensor may be employed to detect the presence of a data storage device (120) within the docking port (115). Upon sensing the presence of a data storage device (120), the mechanical drivers (450) that control the movement of the first and second substrates (400, 405) may be actuated and proceed with the movement of the first and second substrates (400, 405) toward each other in the direction of the arrows (435).

Further, the mechanical drivers (450) that control the movement of the first and second substrates (400, 405) may be configured to apply only a limited amount of force to urge the substrates (400, 405) together to avoid damaging the data storage device (120). This may be done, for example, by sensing an amount of current or power being used by the mechanical drivers (450). In other embodiments, the mechanical drivers (450) may be configured to sense a certain degree of pressure that is asserted on the data storage device (120) being secured between the first and second substrates (400, 405) and may be calibrated to stop applying additional pressure to the first and second substrates (400, 405) at a certain pressure limit in order to avoid damage to the data storage device (120).

While FIG. 5 shows both the first and second substrates (400, 405, respectively) moving to engage the data storage device (120), it will be understood by those skilled in the art that in some embodiments on of the substrates (400, 405) may be fixed with the other substrate moving toward the fixed substrate to engage the data storage device (120). Such an embodiment may have fewer moving parts.

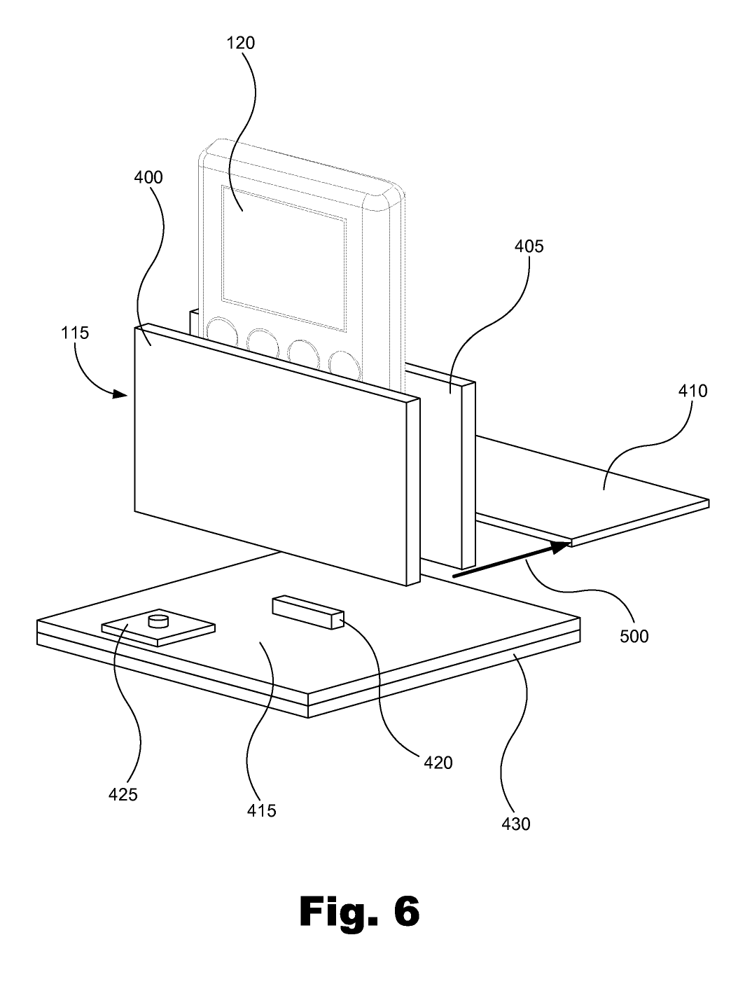

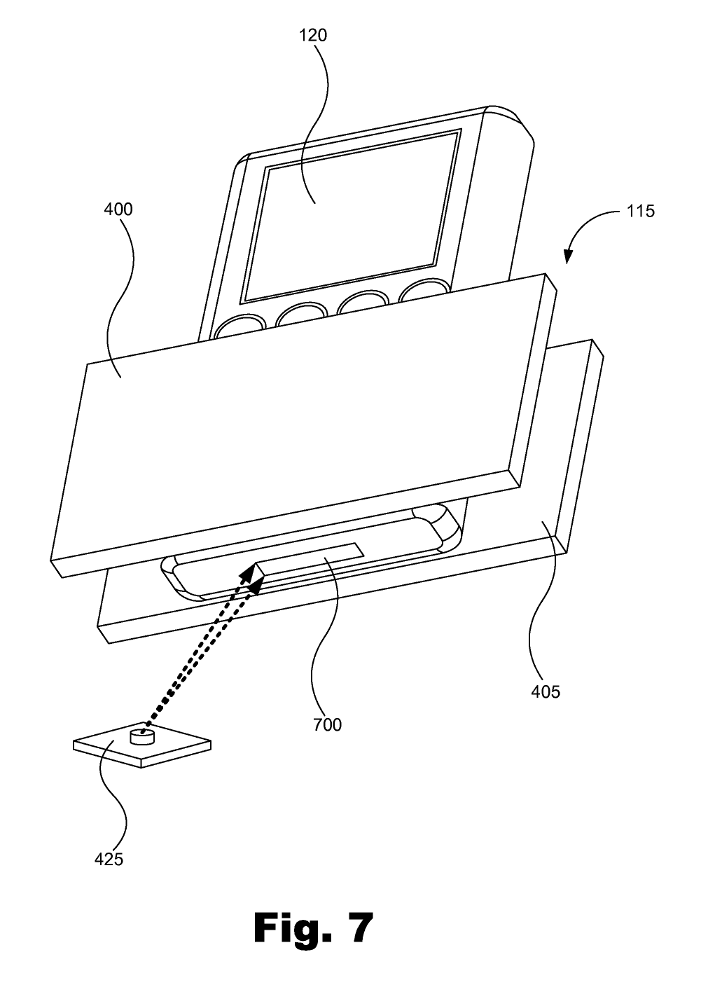

FIG. 6 is yet another prospective view of the docking port and a printed circuit assembly of FIG. 4 receiving a data storage device (120) according to one illustrative embodiment. If the support frame (410) is a substrate as illustrated, the next step in connecting the data storage device (120) to the connector (420) is to remove the third substrate (410). The third substrate (410) is moved away from underneath the first and second substrates (400, 405). The data storage device (120) remains secured between the first and second substrates (400, 405) due to the continuous pressure applied to the first and second substrates (400, 405) as discussed above. The third substrate (410) is moved in the direction of arrow (500) or in any direction or by any means to allow uninterrupted space between the docking port (115) and PCA (415). The data port (700, FIG. 7) of the data storage device (120) is exposed once the third substrate (410) is moved from under the first and second substrates (400, 405). This allows the optical recognition device (425) to detect the data port (700, FIG. 7) of the data storage device (120) and begin the alignment process.

In other embodiments, the support frame (410) may have some other configuration, such as rails that are spaced apart and over which the gripping substrate (400, 405) can slide. In such an embodiment, there may be no need to remove the support frame (410) from beneath the data storage device (120) so as to expose the data port of the data storage device (120) to the connector (420).

Turning now to FIG. 7, a prospective view of the docking port (115) and a data storage device (120) is shown according to one illustrative embodiment. As shown in FIG. 7, the optical recognition device (425) detects the position of a data port (700) of the data storage device (120). In some examples, the optical recognition device (425) may comprise a camera, such as a Charge Coupled Device. The optical recognition device (425) may also contain firmware that analyzes the information or image gathered by the optical recognition device (425) and adjusts the relative alignment of the connector (420) and the data port (700) of the data storage device (120) accordingly.

The detection of the position of the data port (700) of the data storage device (120) may be assisted through various means. One such detection assistance means may include an infrared device communicating between the data storage device (120) and the optical recognition device (425). Another detection assistance means may include manufactured fiducial markings located near or on the edge of the data port (700) of the data storage device (120) which the optical recognition device (425) may more readily detect. Yet another detection assistance means may include post-manufactured stickers for application to the data storage device (120) near the data port (700). The stickers may include fiducial markings which the optical recognition device (425) may more readily detect. These post-manufactured stickers may be produced to adhere to and function for any type of data storage device (120). Further, the stickers may be provided at the retail location where the kiosk is located so that users may easily find and adhere the sticker that corresponds to their particular data storage device (120).

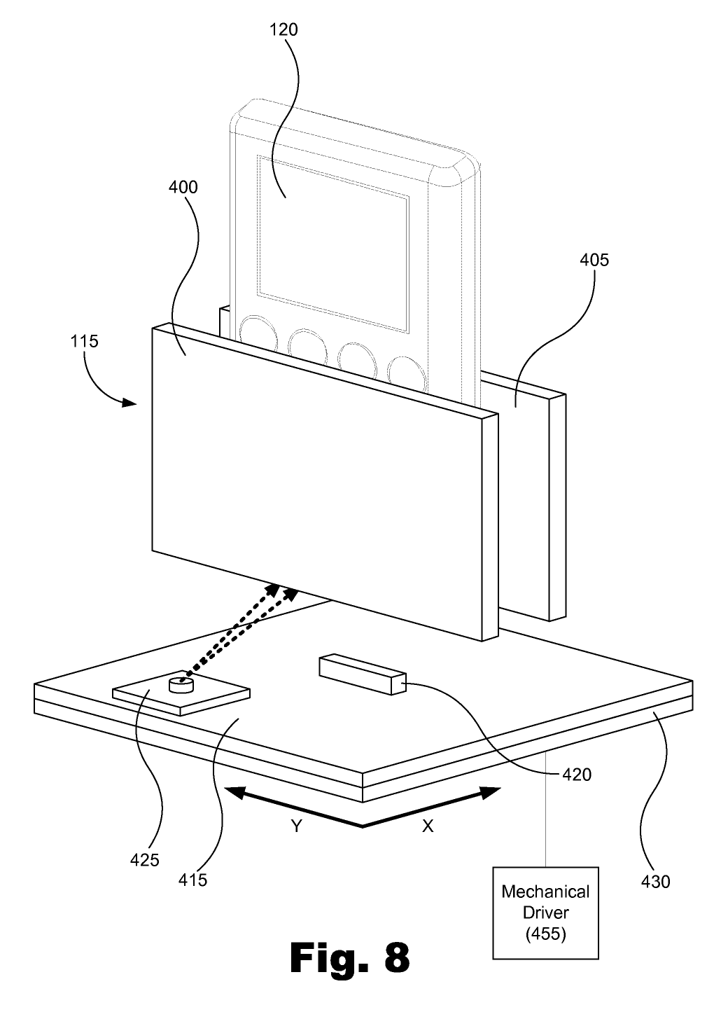

FIG. 8 is a prospective view of the docking port and printed circuit assembly of FIG. 4 depicting the relative horizontal movement of the docking port and a printed circuit assembly according to one illustrative embodiment. As discussed above, the PCA (415) is secured to a PCA substrate (430). The PCA substrate (430) may be operably connected to mechanical drivers (455) located within the kiosk (100) to allow it to move horizontally in the X and Y directions, indicated by the arrows labeled “X” and “Y,” respectively. Information as to the position of the data port (700) of the data storage device (120) is first detected and analyzed by the optical recognition device (425), and that information is then transmitted to the mechanical drivers (455) used to horizontally move the PCA substrate (430). The horizontal alignment of the connector (420) and the data port (700) of the data storage device (120) is thus obtained.

The optical recognition device (425) may be able to determine whether the data port (700) of the data storage device (120) is turned 180 degrees with respect to an expected alignment with the connector (420). If this is the case, the PCA substrate (430) may also be turned 180 degrees so that the connector (420) and the data port (700) of the data storage device (120) are properly aligned. Alternatively, the user interface of the kiosk may instruct the user to reorient the data storage device (120). Further, if the optical recognition device (425) is unable to detect the data port (700) of the data storage device (120), then the kiosk may alert the user of that an error has occurred and that the user should reposition the data storage device (120) within the docking port (115).

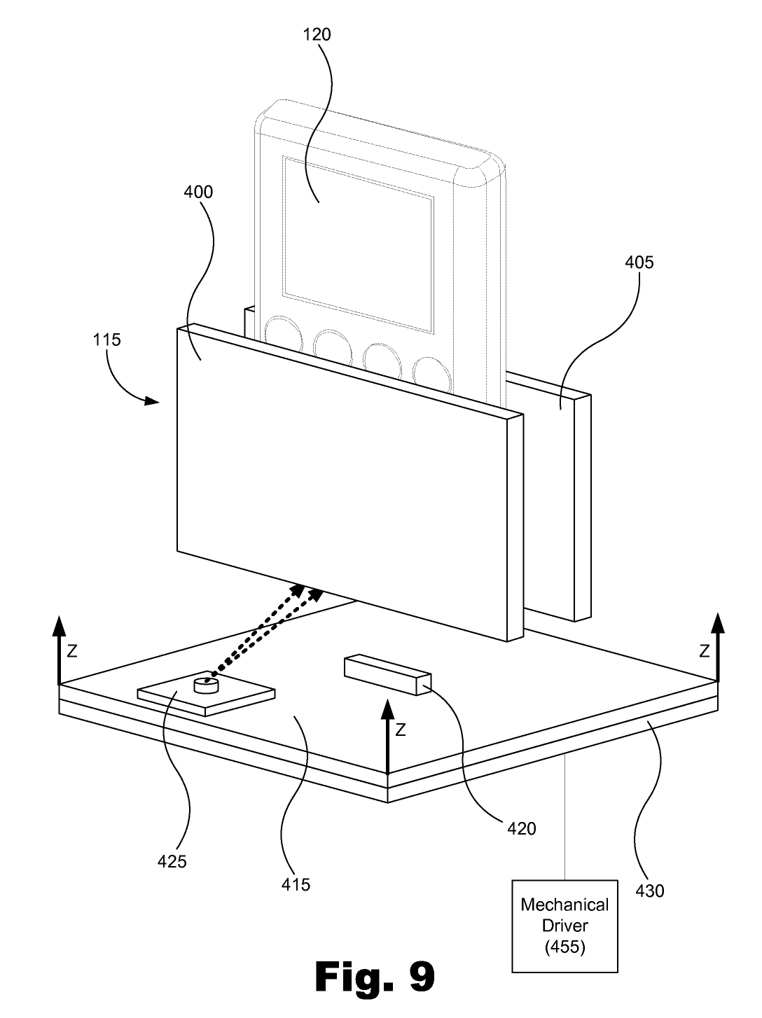

Turning to FIG. 9, another prospective view of the docking port and printed circuit assembly of FIG. 4 is shown depicting the relative vertical movement of the docking port and printed circuit assembly according to one illustrative embodiment. Once the horizontal alignment of the connector (420) and the data port (700) of the data storage device (120) has been achieved, the vertical movement of the PCA substrate (430) towards the data storage device (120) causes the connection or interface of the connector (420) and the data port (700) of the data storage device (120). Again, movement of the mechanical drivers (455) to vertically reposition the PCA substrate (430) allows the connector to couple with the data port (700) of the data storage device (120). As above, the vertical movement of the substrate (430) may be subject to a limited amount of force or pressure so as to prevent damage to the data storage device (120).

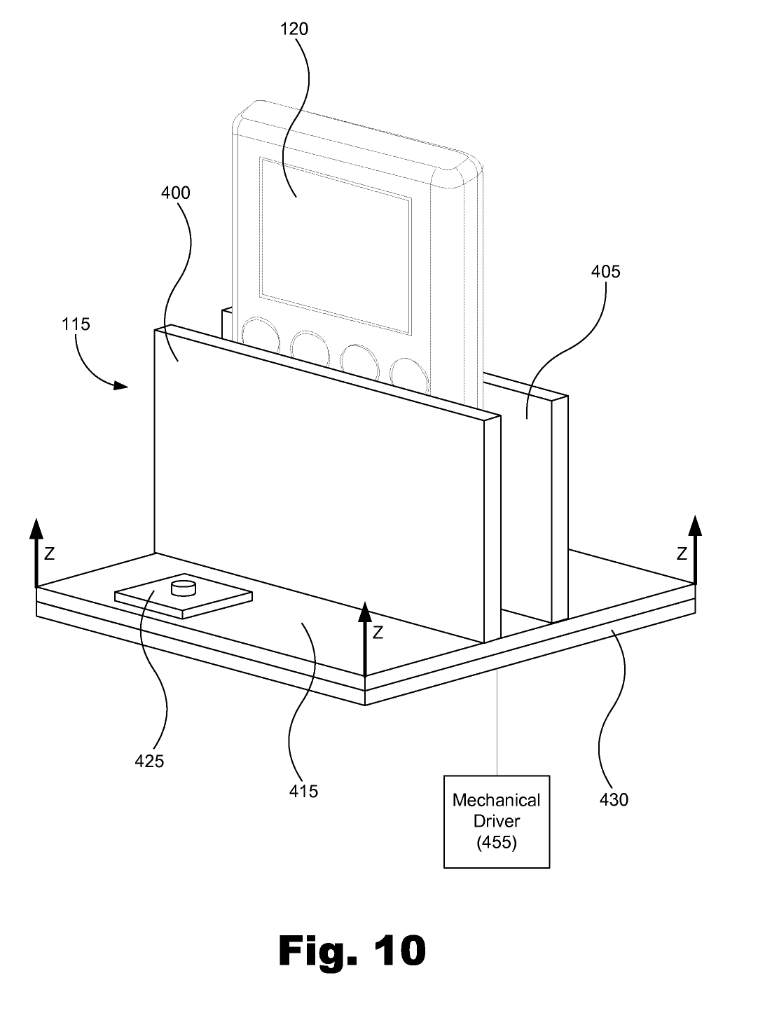

Finally, in FIG. 10, a prospective view of the docking port and the printed circuit assembly of FIG. 4 is shown. As shown in FIG. 10, the data storage device (120) is connected to and in communication with the printed circuit assembly according to one illustrative embodiment. At this point, the data storage device (120) is able to upload data including, among other things, digital image files to the kiosk workflow and edit and/or print the digital images.

Once the data has been transmitted to the kiosk, the PCA substrate (430) is moved away from the data port (700) of the data storage device (120) thus disconnecting the connector (420) from the data port (700) of the data storage device (120). The third substrate (410) is then returned to its previous position underneath the first and second substrates (400, 405). Pressure is released from the first and second substrates (400, 405), and the patron may then retrieve the data storage device (120).

Thus, the present specification provides an interactive kiosk and method that connects with an iPod, iPhone, or any number of other data storage devices automatically without requiring the patron to connect the device himself and without incorporating into the kiosk loose cables, docking ports, cradles or other loose connectors. Thus, image data can be directly loaded to a photo kiosk from a host of data storage devices.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A system comprising:
a docking port with at least one moveable member for releasably engaging any of a plurality of different data storage devices;
at least one data connector disposed adjacent said docking port; and
an optical recognition device for locating a data port on said data storage device;
wherein said optical recognition device controls relative movement between said data storage device and connector such that said data storage device and connector are automatically interfaced by said system.

2. The system of claim 1, wherein said docking port further comprises a first substrate, a second substrate opposed to said first substrate, and a support frame on which at least one of said first and second substrates is movably mounted.

3. The system of claim 2, wherein said optical recognition device is configured to detect a data storage device within said docking port and control a mechanical driver to move at least one of said first and second substrates to engage said data storage device between said substrates.

4. The system of claim 3, wherein said first substrate moves relative to said second substrate, which has a fixed position relative to said support frame, to secure said data storage device between said first substrate and said second substrate.

5. The system of claim 1, wherein said connector is provided on a circuit assembly substrate that is moveable with respect to said docking port so as to align said connector with a data port of said data storage device.

6. The system of claim 5, wherein said at least one connector comprises a plurality of connectors disposed on said circuit assembly substrate, wherein said optical recognition device will determine which of said connectors matches a data port of said data storage device.

7. The system of claim 1, wherein said optical recognition device detects fiducial markings on a data storage device.

8. The system of claim 7, wherein said fiducial markings determine the position of a data port of a data storage device.

9. The system of claim 8, wherein said fiducial markings are located on a sticker adhering to said data storage device.

10. The system of claim 1, wherein said optical recognition device detects the position of a data port of a data storage device via an infrared device communicating between said optical recognition device and a data storage device.

11. A photo print kiosk comprising:
a kiosk housing, said kiosk housing defining a slot;
a docking port disposed in said slot, said docking port comprising at least one moveable member for releasably engaging any of a plurality of different data storage devices;
at least one data connector disposed adjacent said docking port within said kiosk housing, said connector being configured to communicatively couple a data storage device with said kiosk; and
an optical recognition device for locating a data port on said data storage device;
wherein said optical recognition device controls relative movement between said data storage device in said docking port and said connector such that said data storage device and connector are automatically interfaced.

12. The kiosk of claim 11, wherein said docking port further comprises a first substrate, a second substrate opposed to said first substrate, and a support frame on which at least one of said first and second substrates is movably mounted,
wherein said optical recognition device is configured to detect a data storage device within said docking port and control a mechanical driver to move at least one of said first and second substrates to engage said data storage device between said substrates.

13. The kiosk of claim 11, wherein said at least one connector comprises a plurality of different connectors, wherein said optical recognition device is configured to match a data port of said data storage device to a connector of said plurality of connectors and control mechanical drivers to interface said data port of said data storage device with a matching connector of said plurality of connectors.

14. A method of operating a photo print kiosk, said method comprising:
engaging a data storage device in a docking port having at least one moveable member for securing said data storage device in said docking port;
detecting a data port of said data storage device; and
automatically interfacing said data port with a matching connector of a plurality of connectors in said kiosk through relative movement of said data storage device and said matching connector.

15. The method of claim 14, wherein a first member of said docking port moves relative to a second member to secure said data storage device between said first and said second members.

16. The method of claim 14, wherein detecting said data port of said data storage device further comprises detecting a position of said data port of said data storage device and controlling mechanical drivers to achieve said automatic interfacing of said data port with said matching connector.

17. The method of claim 14, wherein automatically interfacing said data port with said matching connector further comprises:
identifying said data port with an optical recognition device of said kiosk; and
identifying said matching connector from among said plurality of connectors such that said matching connector is configured to physically and communicatively couple with said data port of said data storage device.

18. The method of claim 14, further comprising:
transferring image data from said data storage device to said kiosk; and
printing hardcopies of said image file data with said kiosk.

19. The method of claim 14, wherein said data storage device comprises an MP3 player.

20. The method of claim 14, wherein said data storage device comprises a mobile phone.
